(19) United States
(12) Patent Application Publication
(10) Pub. No.: US 2016/0109043 A1
(43) Pub. Date: Apr. 21, 2016

(54) PIPE ADAPTER DEVICE

(71) Applicant: John W. PerMar, JR., Eustis, FL (US)

(72) Inventor: John W. PerMar, JR., Eustis, FL (US)

(21) Appl. No.: 14/519,960

(22) Filed: Oct. 21, 2014

(51) Int. Cl. F16L 19/07; F16L 19/00; F16L 19/08; F16L 21/035

(52) U.S. Cl. CPC F16L 19/07; F16L 21/035; F16L 19/005; F16L 19/08

(57) ABSTRACT

A pipe adapter may include an inner tube member, a fastener member, an outer sleeve member, a compressible sleeve member, and a fitting member. The inner tube member may have a proximal section and a distal section. The fastener member may be connected to the inner tube member along the proximal section thereof. The outer sleeve member may girdle the inner tube member and may be connected to and extend outwardly from the fastener member. The compressible sleeve member may be connected to and may extend outwardly from the outer sleeve member and may be positioned to overlie the inner tube member. The fitting member may be connected to the distal section of the inner tube member and may be in communication with the compressible sleeve member. At least a portion of the fitting member and/or the compressible sleeve member may be positionable within a portion of a pipe.

### FIELD OF THE INVENTION

The present invention relates to devices, systems, and methods for pipe adapters, fittings, and connectors, and more specifically, to pipe adapters that allow a broken fitting to be replaced.

### BACKGROUND

Pipes and pipe fittings are present in nearly every building. When pipe fittings break, it can often be problematic to fix due in many instances to the fact that space is limited or other objects prevent a replacement part from being used.

When broken fittings cannot be removed, one solution is to cut the pipe and remove the fitting along with a portion of the pipe. Adapters are sometimes used to connect to the remaining pipe, but are generally connected to an exterior portion of the remaining pipe. For instance, a sleeve may be used that fits around the outside portion of the remaining pipe and crimp rings may be used to secure the sleeve. A sleeve may require access to the outside portion of the remaining pipe as well as tool access to the crimp rings. When space is limited, the lack of access can make it difficult, if not impossible, to install such an adapter.

For example, if a sufficient length of pipe does not exist and, more specifically, a length of the outside portion of the pipe available for use, the entire pipe will likely have to be replaced, resulting in higher costs associated with such a repair. Further, if the pipe happens to be protruding through a brick or block wall, for instance, the wall may have to be partially or completely removed to access the pipe, which would also increase the costs of such a repair.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

Accordingly, a pipe adapter that connects to the remaining pipe through an inside portion of the remaining pipe as opposed to the outside is desirable. Such a solution would advantageously allow for a fitting, pipe, or other object to be connected to the pipe adapter, thus removing, or nearly removing, the need to ever access the outside of the remaining pipe. Such a solution would also advantageously decrease costs associated with repair of a broken pipe.

The present invention provides a pipe adapter that addresses the shortcomings of the prior art, and that provides an elegant solution to the problem of repairing a pipe fitting. More specifically, the present invention advantageously provides a pipe adapter device that provides a reliable repair to a broken pipe fitting. Further, the present invention advantageously provides a pipe adapter device that allows for a low-cost repair of a broken pipe fitting. The present invention also advantageously provides an embodiment of a pipe adapter device that can be readily installed with minimal effort.

With the above in mind, embodiments of the present invention are related to a pipe adapter which may include an inner tube member, a fastener member, an outer sleeve member, a compressible sleeve member, and a fitting member. The inner tube member may have a proximal section and a distal section. The fastener member may be connected to the inner tube member along the proximal section thereof. The outer sleeve member may girdle the inner tube member and may be connected to and may extend outwardly from the fastener member. The compressible sleeve member may be connected to and may extend outwardly from the outer sleeve member and may be positioned to overlie the inner tube member. The fitting member may be connected to the distal section of the inner tube member and may be in communication with the compressible sleeve member.

At least a portion of the fitting member and/or the compressible sleeve member may be positionable within a portion of a pipe. Rotating the fastener member may cause the compressible sleeve member to be compressed and at least a portion of exterior walls thereof to expand outwardly from a longitudinal axis of the inner tube member and in a direction toward an inner surface of the pipe.

The fastener member may have a threaded end. The fastener member may include a polygonal shaped portion connected to the threaded end.

The fitting member may include a first fitting member and a second fitting member. The first fitting member may be a nose cone which may be connected to the distal section of the inner tube member. The second fitting member may be a lock sleeve. The second fitting member may be configured to matingly engage at least a portion of the nose cone. Rotation of the fastening member may cause the lock sleeve to be compressed so that exterior walls of the lock sleeve may expand outwardly from the longitudinal axis and in a direction toward the inner surface of the pipe. The first fitting member may also be a barbed ring.

The fastener member may include a first and second fastener member. Rotating the first fastener member may cause the first fitting member to further matingly engage the second fitting member. Exterior walls of the second fitting member may expand outwardly from the longitudinal axis and in a direction toward the inner surface of the pipe. Rotating the second fastener member may cause the compressible sleeve member to be compressed and at least a portion of exterior walls thereof to expand outwardly from the longitudinal axis of the inner tube member and in a direction toward the inner surface of the pipe.

The first fitting member may be connected to the distal section of the inner tube member and may be in communication with the compressible sleeve member. The second fitting member may be configured to matingly engage the first fitting member. At least a portion of the first fitting member, the second fitting member, and/or the compressible sleeve member may be positionable within a portion of the pipe.

The pipe adapter may further include an O-ring which may be positioned between the inner tube member and an interior wall of the outer sleeve member. The inner tube member may include a grooved section which may be configured to matingly engage the O-ring. An end of the inner tube member may be tapered and/or threaded.

Outward expansion of the compressible sleeve member may be configured to create a liquid-tight and/or a gas-tight seal with the pipe. The compressible sleeve member may be configured in a series of rings, a helical configuration, and/or a single piece of material.

The distal section of the inner tube member may include a grooved member which may be configured to matingly engage the fitting member. The proximal section of the inner tube member may include an opening that may be polygonal, circular, oval, generally polygonal, generally circular, and/or generally oval. The opening may include a slot.

The fastener member may have a first end, a second end, and a medial section. The inner tube member may include a first inner tube member and a second inner tube member. The first inner tube member may be connected to and may extend outwardly from the first end of the fastener member. The second inner tube member may be connected to and may extend outwardly from the second end of the fastener member.

The outer sleeve member may include a first outer sleeve member that may girdle the first inner tube member. The first outer sleeve member may be connected to and may extend outwardly from the first end of the fastener member. The outer sleeve member may also include a second outer sleeve member that may girdle the second inner tube member. The second outer sleeve member may be connected to and may extend outwardly from the second end of the fastener member.

The compressible sleeve member may include a first compressible sleeve member which may be connected to and may extend outwardly from the first outer sleeve member and may be positioned to overlie the first inner tube member. The compressible sleeve member may include a second compressible sleeve member which may be connected to and may extend outwardly from the second outer sleeve member and may be positioned to overlie the second inner tube member.

The first fitting member may be adapted to be connected to the first inner tube member and may be in communication with the first compressible sleeve member. The second fitting member may be adapted to be connected to the second inner tube member and may be in communication with the second compressible sleeve member.

At least a portion of the first fitting member and/or the first compressible sleeve member may be positionable within a portion of a first pipe. At least a portion of the second fitting member and/or the second compressible sleeve member may be positionable within a portion of a second pipe. Rotating the first end and/or the second end may cause at least a portion of exterior walls of the first compressible sleeve member and/or the second compressible sleeve member to expand outwardly from longitudinal axis of the respective first and second inner tube members in a direction toward an inner surface of the respective first and second pipes.

### BRIEF DESCRIPTION OF THE DRAWINGS

FIG. 1A is an exploded partial perspective view of a pipe adapter according to an embodiment of the present invention being connected to a pipe.

FIG. 1B is a partial exploded perspective view of the pipe adapter of FIG. 1A being connected to a pipe.

FIG. 1C is a cross section view of the pipe adapter of FIG. 1A and taken through line 1C-1C.

FIG. 1D is a partial perspective view of a proximal section of the pipe adapter of FIG. 1A.

FIG. 1E is a side elevation view of a fitting member of the pipe adapter of FIG. 1A.

FIG. 2A is a perspective view of a pipe adapter according to another embodiment of the present invention.

FIG. 2B is a perspective view of two washers that may be used in connection with the pipe adapter of FIG. 2A.

FIG. 3 is a perspective view of a pipe adapter according to yet another embodiment of the present invention.

FIG. 4 is a perspective view of a pipe adapter according to still another embodiment of the present invention.

FIG. 5 is a perspective view of a pipe adapter according to another embodiment of the present invention.

FIG. 6A is a partially exploded perspective view of a pipe adapter according to yet another embodiment of the present invention.

FIG. 6B is an exploded perspective view of the pipe adapter of FIG. 6A.

FIG. 6C is a cross section view of the pipe adapter of FIG. 6A and taken through line 6C-6C.

FIG. 7 is a perspective view of a pipe adapter according to still another embodiment of the present invention.

FIG. 8 is a perspective view of a pipe adapter according to another embodiment of the present invention.

FIG. 9 is a perspective view of a kit for assembling a pipe adapter according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

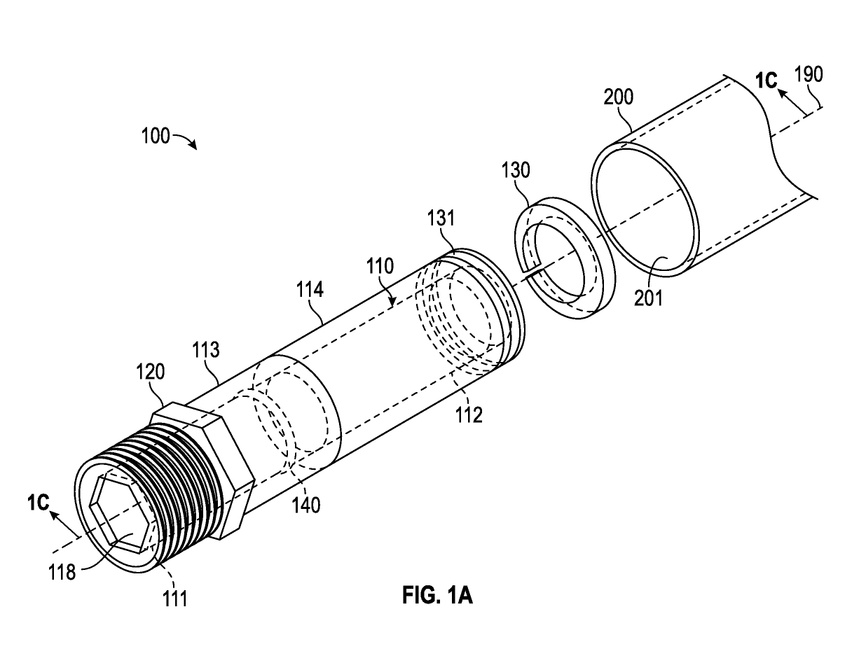

Referring to FIGS. 1A-1C, an embodiment of the invention, as shown and described by the various figures and accompanying text, provides a pipe adapter 100 which may include an inner tube member 110, a fastener member 120, an outer sleeve member 113, a compressible sleeve member 114, and a fitting member 130. The inner tube member 110 may have a proximal section 111 and a distal section 112. The proximal section 111 may be generally one end of the inner tube member 110. The distal section 112 may be generally the opposite end of the inner tube member 110. More specifically, and without limitation, the proximal section 111 may include a portion of the inner tube member 110, the outer sleeve member 113, and/or the fastener member 120, and the distal section 112 may include a portion of the inner tube member 110, the compressible sleeve member 114, and/or the fitting member 130.

In another example, and without limitation, the proximal section 111 may include a portion of the inner tube member 110 and/or the fastener member 120 and the distal section 112 may include a portion of the inner tube member 110, the outer sleeve member 113, the compressible sleeve member 114, and/or the fitting member 130.

The fastener member 120 may be connected to the inner tube member 110 along the proximal section 111 thereof. The outer sleeve member 113 may girdle the inner tube member 110 and may be connected to and may extend outwardly from the fastener member 120. The compressible sleeve member 114 may be connected to and may extend outwardly from the outer sleeve member 113 and may be positioned to overlie the inner tube member 110.

The fitting member 130 may be connected to the distal section 112 of the inner tube member 110 and may be in communication with the compressible sleeve member 114. As perhaps best illustrated in FIG. 1E, the fitting member 130 may be a lock ring, may be cam shaped, and may further include an opening. The fitting member 130 may be a cam lock washer, a flat washer, a c-clip, and/or a beveled washer. Those skilled in the art will appreciate that the fitting member 130 may also be provided by any other device suitable for matingly engaging the compressible sleeve member 114. The fitting member 130 may matingly engage with a grooved member 131. The grooved member 131 may be attached to a portion of the inner tube member 110 and/or the compressible sleeve member 114. The distal section 112 of the inner tube member 110 may include the grooved member 131. Those skilled in the art will appreciate that any type of fitting may be used as the fitting member 130 as desired. The fastener member 130 may girdle at least one of the inner tube member 110, the outer sleeve member 113, and/or the compressible sleeve member 114.

At least a portion of one or each of the inner tube member 110, the outer sleeve member 113, the compressible sleeve member 114, the fastener member 120, and/or the fitting member 130 may be positionable within a portion of a pipe 200. Rotating the fastener member 120 may cause the compressible sleeve member 114 to be compressed and at least a portion of exterior walls thereof to expand outwardly from a longitudinal axis 190 of the inner tube member 110 and in a direction toward an inner surface 201 of the pipe 200.

The fastener member 120 may have an end that is threaded. The fastener member 120 may include a polygonal shaped portion connected to the threaded end. For example, and without limitation, the fastener member 120 may be threaded on at least a portion of the outer diameter and/or on at least a portion of the internal diameter and at least a portion of the outer diameter may be polygonal shaped. As another example, and without limitation, the fastener member 120 may be threaded on generally half of the outer diameter and on generally half of the internal diameter and the remaining generally half of the outer diameter may be polygonal shaped. For example, and without limitation, the fastener member 120 may include threading on the external diameter which may matingly engage with a hose bib, bibcock fitting, or other fitting as desired. Those skilled in the art will appreciate that the fastener member 120 may be any type of adapter, or more specifically pipe adapter fastener or pipe fastener, as desired.

The inner tube member 110 may have an opening 118 that is circular and/or polygonal shaped. The opening 118 may be polygonal, circular, oval, generally polygonal, generally circular, and/or generally oval. For example, and without limitation, the opening 118 may be hexagonal shaped so that a device can be used to rotate the inner tube member 110. In addition, a slot 119 or a plurality of slots 119 may be included in the opening 118 as illustrated in FIG. 1D.

The compressible sleeve member 114 may be flexible, compressible, stretchable, and/or expandable. For example, and without limitation, the compressible sleeve member 114 may be a single piece of cylindrical rubber. Additionally, the compressible sleeve member 114 may be a helical strand of rubber or numerous pieces of rubber, such as a plurality of O-rings. Those skilled in the art will appreciate that the compressible sleeve member 114 may be provided by numerous configurations and materials as desired.

The pipe adapter 100 may further include an O-ring 140 which may be positioned between the inner tube member 110 and an interior wall of the outer sleeve member 113. The inner tube member 110 may comprise a grooved section 115 which may be configured to matingly receive the O-ring 140.

An end of the inner tube member 110 may be tapered and/or threaded. For example, and without limitation, the inner tube member 110 may be threaded on the outer diameter and/or on the inner diameter. The inner tube member 110 may matingly engage with the fastener member 120. More specifically, threads on the outer diameter of the inner tube member may matingly engage with threads on the inner diameter of the fastener member 120. Outward expansion of the compressible sleeve member 114 may be configured to create a solid-tight, a liquid-tight, a plasma-tight, and/or a gas-tight seal with the pipe 200. The compressible sleeve member 114 may be configured in a series of rings, a helical configuration, and/or a single piece of material.

The pipe adapter 100 may be used for all or nearly all types of pipe and pipe fittings applications. For example, and without limitation, the pipe adapter 100 may be used in the plumbing industry, gas industry, hydraulic industry, residential settings, or in any other commercial setting. For instance, the pipe adapter may be used in any application involving any pipe, fitting, or pipe-like object which may convey or is intended to convey liquid, gas, plasma, and/or a solid.

Those skilled in the art will appreciate that the pipe adapter 100 and various components thereof may be any size, i.e., length, diameter, thickness, etc. as desired. Those skilled in the art will also appreciate that the pipe adapter 100 and various components thereof may be any material, i.e., rubber, metal, metal alloy, plastic, polyvinyl chloride (PVC), chlorinated polyvinyl chloride (CPVC), acrylonitrile butadiene styrene (ABS), high-density polyethylene (HDPE), crosslinked polyethylene, clay, etc. as desired. Additionally, each component of the pipe adapter 100 may be separate, integrally formed or molded, or any combination thereof.

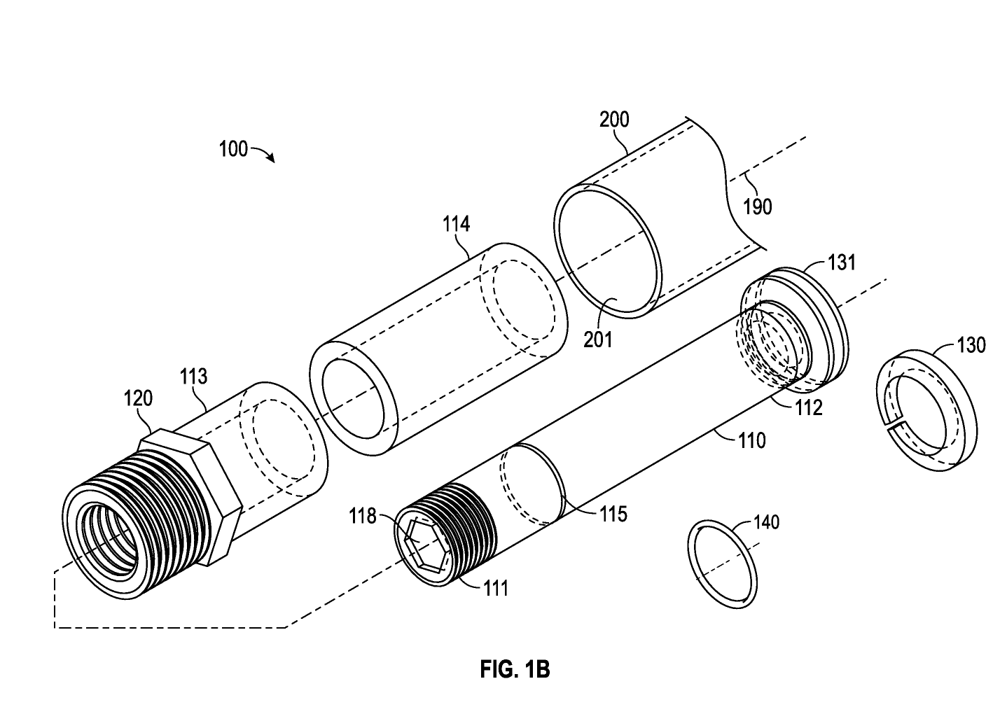

Referring now additionally to FIG. 2A, another embodiment of the pipe adapter 100′ according to the present invention is now disclosed in greater detail. More specifically, the pipe adapter 100′ may further include a washer 150′. The washer 150′ may be a plurality of washers 150′. The washer 150′ may girdle the inner tube member 110′, the outer sleeve member 113′, and/or the compressible sleeve member 114′. Those skilled in the art will appreciate that the washer 150′ may be any type of washer, including, but not limited to, a flat washer, a cam lock washer, a beveled locking washer, a locking washer, and/or a beveled washer. For example, and without limitation, as illustrated in FIG. 2A, three washers 150′ may be used as flat washers and two additional washers 150′ may be used that are beveled washers. As illustrated in FIG. 2B, in place of one or more of the five washers 150′ illustrated in FIG. 2A, two washers 150′ that are beveled washers may be used. Those skilled in the art will appreciate that any combination and any number of washers 150′ may be used as desired.

The other elements of this embodiment of the pipe adapter 100′ that are not specifically recited herein are labeled with single prime notation, are similar to that of the first embodiment of the pipe adapter 100, and require no further discussion herein.

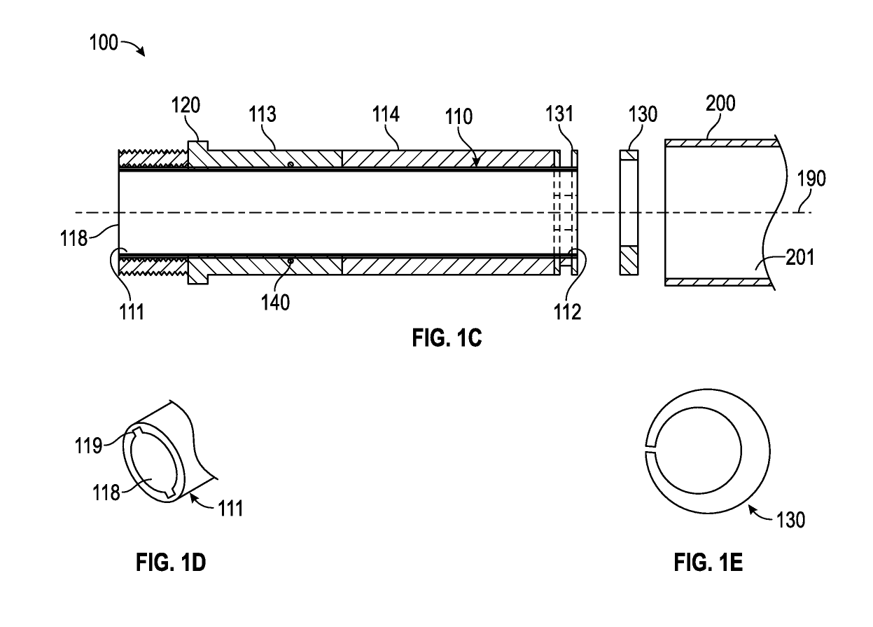

Referring now additionally to FIG. 3, another embodiment of the pipe adapter 100″ according to the present invention is now described in greater detail. More specifically, and with reference to the fitting member 130″, the fitting member 130″ may include a first fitting member 180″ and a second fitting member 181″. The first fitting member 180″ may be a flange. The first fitting member 180″ may be connected to the inner tube member 110″, such as at the distal section 112″, and may be in communication with the compressible sleeve member 114″.

For example, and without limitation, the first fitting member 180″ may provide resistance to the compressible sleeve member 114″ when the compressible sleeve member 114″ is compressed, thereby forcing the compressible sleeve member 114″ to expand outward from the longitudinal axis 190″ toward the inner surface 201″ of the pipe 200″.

The second fitting member 181″ may be a lock sleeve. As illustrated, two second fitting members 181″ may be included in the pipe adapter 100″. When compressed toward each other, the two second fitting members 181″ may move outwardly from the longitudinal axis 190″ toward the inner surface 201″ of the pipe 200″. As further illustrated, the pipe adapter 100″ may include a washer 150″ located adjacent to one of the two second fitting members 181″ on each side of the second fitting members 181″. Those skilled in the art will appreciate that any combination and any number of first fitting members 180″, second fitting members 181″ and washers 150″ may be used as desired.

When the second fitting member 181″ is a lock sleeve, the second fitting member 181″ may be a non-continuous ring that may have an angled slit through it and which may allow for compression thereof so that as the second fitting member 181″ is compressed, the diameter of the second fitting member 181″ increases. As the diameter of the second fitting member 181″ increases, the exterior walls of the second fitting member 181″ may expand outwardly from the longitudinal axis 190″ and in a direction toward the inner surface 201″ of the pipe 200″. The second fitting member 181″ may also be two half fittings which may communicate as described herein. The second fitting member 181″ may include a first portion or a first half that is attached to the outer sleeve member 113″ and a second portion or a second half that is attached to the compressible sleeve member 114″.

For example, and without limitation, the second fitting member 181″ may be a lock sleeve and rotation of the fastening member 120″ may cause the second fitting member 181″ to be compressed so that exterior walls of the second fitting member 181″ may expand outwardly from the longitudinal axis 190″ and in a direction toward the inner surface 201″ of the pipe 200″. At least a portion of the first fitting member 180″′, the second fitting member 181′″, and/or the compressible sleeve member 114″′ may be positionable within a portion of the pipe 200″.

The other elements of this embodiment of the pipe adapter 100″ that are not specifically recited herein are labeled with double prime notation, are similar to that of one or more embodiments of the pipe adapter 100, 100′ previously described, and require no further discussion herein.

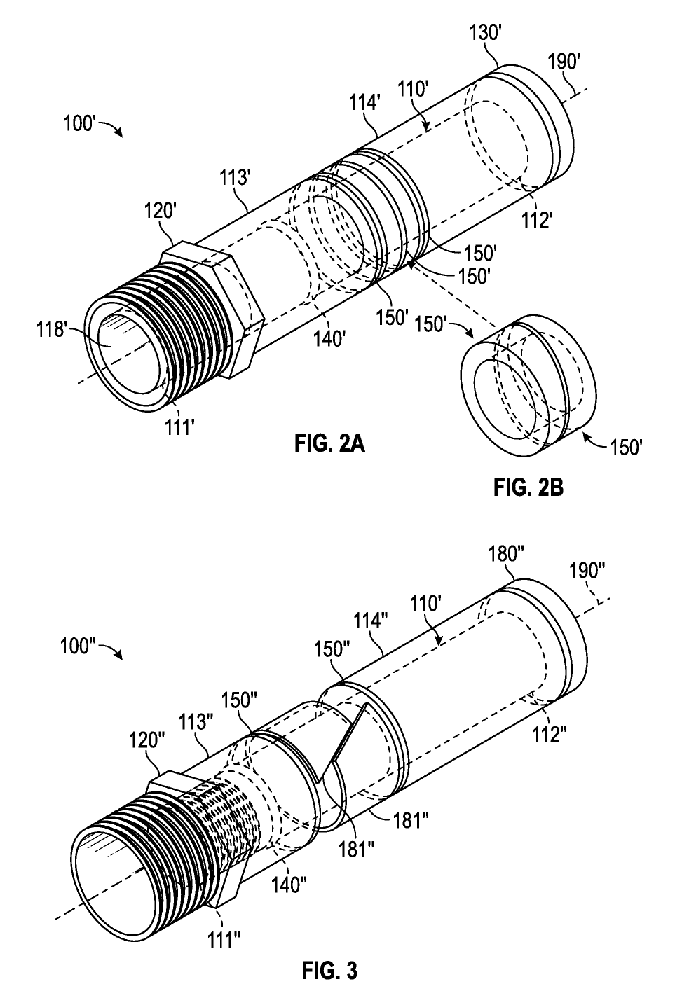

Referring now additionally to FIG. 4, another embodiment of the pipe adapter 100″′ according to the present invention is now disclosed in greater detail. More specifically, and with reference to the first fitting member 180″ and the second fitting member 181″′, the first fitting member 180″′ may be a nose cone connected to the distal section 112″′ of the inner tube member 110″′ and the second fitting member 181″′ may be a lock sleeve which may be configured to matingly engage at least a portion of the nose cone. When the first fitting member 180″′ is matingly engaged with the second fitting member 181″′, the first fitting member 180″′ may expand outwardly from the longitudinal axis 190″′ toward the inner surface 201″′ of the pipe 200″′. As a result of the first fitting member 180″′ expanding, the first fitting member 180″′ may communicate with the inner surface 201″′ of the pipe 200″′ thus preventing or hindering the pipe adapter 100″′ from being removed from the pipe 200″′ once installed.

In addition, the fastener member 120″′ may include a first fastener member 121″′ and a second fastener member 122″′. The first fastener member 121″′ and the second fastener member 122″′ may include a threaded portion which may extend outwardly from the first fastener member 121″′ and/or the second fastener member 122″′ along the longitudinal axis 190″′. More specifically, the threaded portion extends along the longitudinal axis 190″′, but is oriented normal to the longitudinal axis 190″′. The threaded portion of the first fastener member 121″′ and the second fastener member 122″′ may include threading on the external diameter and internal diameter. The threading on the external diameter may matingly engage with a hose bib, bibcock fitting, or other fitting as desired. Those skilled in the art will appreciate that the first and second fastener member 121″′, 122″′ may be any type of adapter, or more specifically pipe adapter fastener or pipe fastener, as desired. The threading on the internal diameter may matingly (threadably) engage the inner tube member 110″′ or other fitting as desired. Those skilled in the art will appreciate that the first fastener member 121″′ and the second fastener member 122″′ may also connect to the inner tube member 110″′ by any means such as glue, adhesive, fastener, screw, bolt, welding, or any other means understood by those having the benefit of this disclosure.

Rotating the first fastener member 121″′ may cause the first fitting member 180″′ to further matingly engage the second fitting member 181″′. Exterior walls of the second fitting member 181″′ may expand outwardly from the longitudinal axis 190″′ and in a direction toward the inner surface 201″′ of the pipe 200″′. Rotating the second fastener member 122″′ may cause the compressible sleeve member 114″′ to be compressed and at least a portion of exterior walls thereof to expand outwardly from the longitudinal axis 190″′ of the inner tube member 110″′ and in a direction toward the inner surface 201″′ of the pipe 200″′. The first fastener member 121″′ may be connected to the inner tube member 110″′ along the proximal section 111″′ thereof. The outer sleeve member 113″′ may be connected to and may extend outwardly from the first fastener member 121″′ or the second fastener member 122″. Those skilled in the art will appreciate that any number of fastener members 120″′ may be used. Those skilled in the art will also appreciate that a portion of the first fastener member 121″′ and/or a portion of the second fastener member 122″′ may include a polygonal feature to matingly engage with various tools which may further allow rotation of the first fastener member 121″′ and/or the second fastener member 122″′ together.

For example, and without limitation, the polygonal feature of the first fastener member 121″′ and the second fastener member 122″′ may be hexagonal shaped so that a wrench may matingly engage with each separately or jointly, thus allowing a user to turn the first fastener member 121″′ or the second fastener member 122″′ while not turning the other. A user may also be able to turn both the first fastener member 121″′ and the second fastener member 122″′.

The other elements of this embodiment of the pipe adapter 100″′ that are not specifically recited herein are labeled with triple prime notation, are similar to that of one or more embodiments of the pipe adapter 100, 100′, 100″ previously described, and require no further discussion herein.

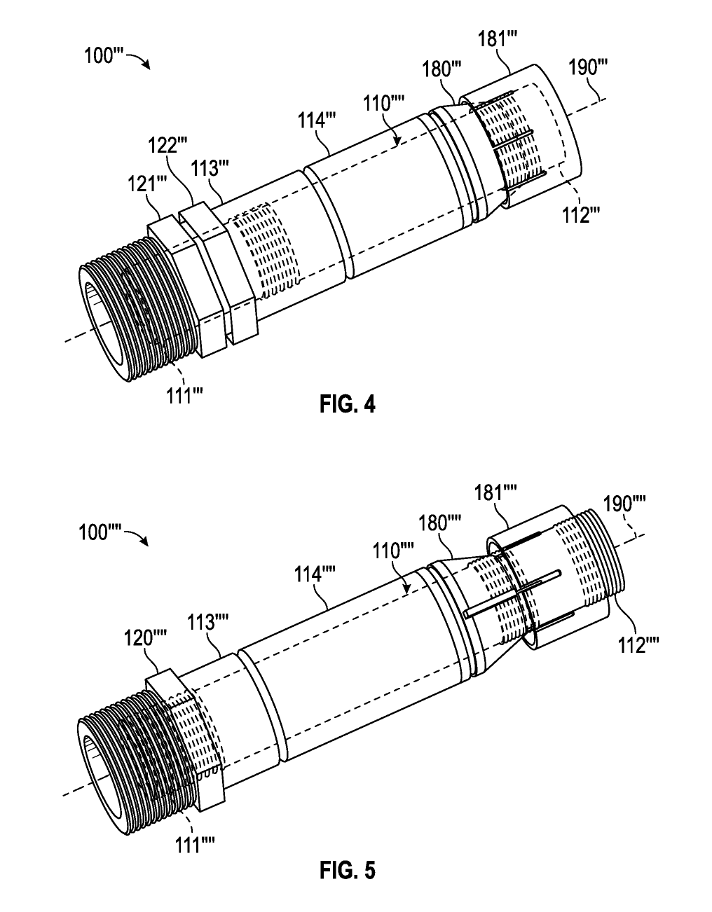

Referring now additionally to FIG. 5, another embodiment of the pipe adapter 100″″ according to the present invention is now disclosed in greater detail. More specifically, and with reference to the distal section 112″″ of the inner tube member 110″″, the distal section 112″″ may include a portion that is reverse threaded. In addition to the portion that is reverse threaded, the distal section 112″″ may also include a portion that is threaded in the standard direction.

For example, and without limitation, the portion that is reverse threaded may allow the compressible sleeve member 114″″, the first fitting member 180″″, and/or the second fitting member 181″″ to matingly (or threadably) engage with the inner tube member 110″″. The second fitting member 181″″ or another device or fitting may matingly (or threadably) engage the portion that is threaded in the standard direction.

As another example, and without limitation, the portion that is reverse threaded may allow the second fitting member 181″″ or another device or fitting to matingly (or threadably) engage the inner tube member 110″″. The compressible sleeve member 114″″, the first fitting member 180″″, and/or the second fitting member 181″″ may matingly engage the portion that is reverse threaded. This may prevent or hinder components of the pipe adapter 100″″, including, but not limited to, the compressible sleeve member 114″″, the first fitting member 180″″, and/or the second fitting member 181″″ from disengaging from the pipe adapter 100″″.

The other elements of this embodiment of the pipe adapter 100″″ that are not specifically recited herein are labeled with quadruple prime notation, are similar to that of one or more embodiments of the pipe adapter 100, 100′, 100″, 100″′ previously described, and require no further discussion herein.

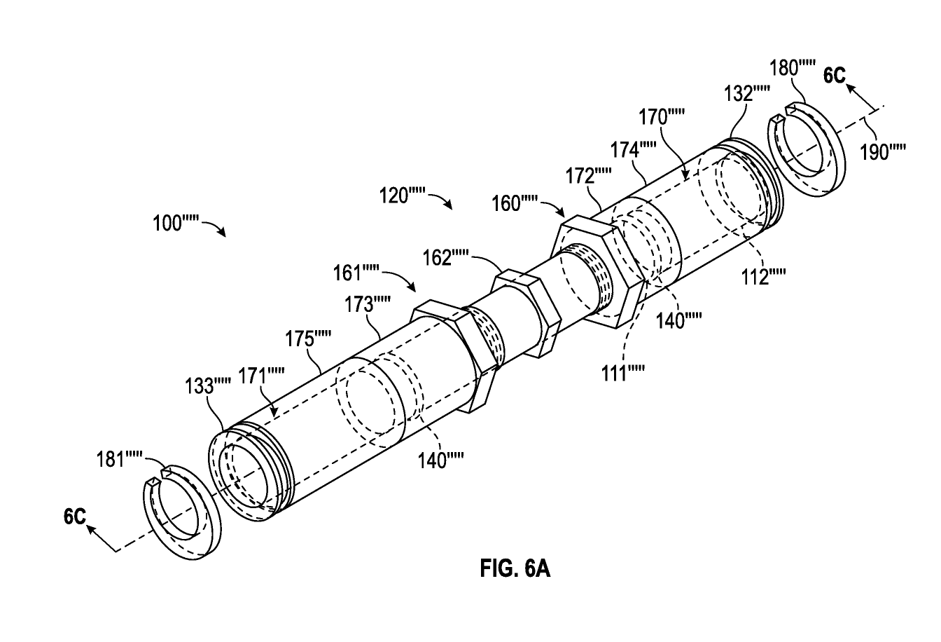

Referring now additionally to FIGS. 6A-6C, another embodiment of the pipe adapter 100″″′ according to the present invention is now disclosed in greater detail. More specifically, and with reference to the first fitting member 180″″′ and the second fitting member 181″″′, the first fitting member 180″″′ and/or the second fitting member 181″″′ may be a nose cone and one or both may be configured to matingly engage at least a portion of a lock sleeve.

The fastener member 120″″′ may have a first end 160″″′, a second end 161″″′, and a medial section 162″″′. The inner tube member 110″″′ may include a first inner tube member 170″″′ and a second inner tube member 171″″′. The first inner tube member 170″″′ may be connected to and may extend outwardly from the first end 160″″′ of the fastener member 120″″′. The first inner tube member 170″″′ may have a proximal section 111″′ and a distal section 112″″′. The second inner tube member 171″″′ may be connected to and may extend outwardly from the second end 161″″′ of the fastener member 120″″′. The outer sleeve member 113″″′ may include a first outer sleeve member 172″″′ which may girdle the first inner tube member 170″″′ and may be connected to and may extend outwardly from the first end 160″″′ of the fastener member 120″″′. The outer sleeve member 113″″′ may also include a second outer sleeve member 173″′ that may girdle the second inner tube member 171″″′ and may be connected to and may extend outwardly from the second end 161″″′ of the fastener member 120″″′.

The compressible sleeve member 114″″′ may include a first and second compressible sleeve member 174″″′, 175″″′. The first compressible sleeve member 174″″′ may be connected to and may extend outwardly from the first outer sleeve member 172″″′ and may be positioned to overlie the first inner tube member 170″″′. The second compressible sleeve member 175″″′ may be connected to and may extend outwardly from the second outer sleeve member 173″″′ and may be positioned to overlie the second inner tube member 171″″′. The fitting member 130″″′ may include a first fitting member 180″″′ which may be adapted to be connected to the first inner tube member 170″″′ and may be in communication with the first compressible sleeve member 174″″′. The first fitting member 180″″′ may also be adapted to be connected to the distal section 112″″′ of the first inner tube member 170″″′. The fitting member 130″″′ may also include a second fitting member 181″″′ which may be adapted to be connected to the second inner tube member 171″″′ and may be in communication with the second compressible sleeve member 175″″′.

At least a portion of the first fitting member 180″″′ and/or the first compressible sleeve member 174″″′ may be positionable within a portion of a first pipe. At least a portion of the second fitting member 181″″′ and/or the second compressible sleeve member 175″′ may be positionable within a portion of a second pipe. Rotating the first end 160″″′ and/or the second end 161″″′ may cause at least a portion of exterior walls of the first compressible sleeve member 172″″′ and/or the second compressible sleeve member 173″″′ to expand outwardly from a longitudinal axis 190″″′ of the respective first and second inner tube members 170″″′, 171″″′ in a direction toward an inner surface of the respective first and second pipes.

Rotating the first end 160″″′, the second end 161″″′, the medial section 162″″′, the first outer sleeve member 172″″′, and/or the second outer sleeve member 173″″′ may cause the first compressible sleeve member 174″″′ and/or the second compressible sleeve member 175″″′ to be compressed and at least a portion of exterior walls thereof to expand outwardly from the longitudinal axis 190″″′ of the respective first and second inner tube members 170″″′, 171″″′ and in a direction toward an inner surface of the respective first and second pipes.

The O-ring 140″″′ or a plurality of O-rings 140″″′ may girdle the first inner tube member 170″″′ and/or the second inner tube member 171″″′. The inner tube member 110″″′, the first inner tube member 170″″′, and/or the second inner tube member 171″″′ may include a first and second grooved section 116″″′, 117″″′. The O-ring 140″′ or plurality of O-rings 140″″′ may matingly engage the first grooved section 116″″′ and/or the second grooved section 117″″′.

As illustrated, a portion of the first end 160″″′ may be threaded and may matingly engage with a portion of the first outer sleeve member 172″″′. The first end 160″″′ and at least the portion of the first outer sleeve member 172″″′ may be integrally attached and/or molded. Alternatively, the proximal section 111″′ and/or the first inner tube member 170″″′ may be integrally attached and/or molded to the first end 160″″′ and/or the fastener member 120″″′. Those skilled in the art will appreciate that the proximal section 111″″′, the fastener member 120″″′, the first inner tube member 170″″′, and/or the first end 160″″′ may be attached by any means including, but not limited to, glue, adhesive, fastener, screw, bolt, welding, or any other means understood by those having the benefit of this disclosure.

As illustrated, a portion of the second end 161″″′ may be threaded and may matingly engage with a portion of the second outer sleeve member 173″″′. The second end 161″″′ and at least the portion of the second outer sleeve member 173″″′ may be integrally attached and/or molded. Alternatively, the second inner tube member 171″″′ may be integrally attached and/or molded to the second end 161″″′ and/or the fastener member 120″″′. Those skilled in the art will appreciate that the fastener member 120″″′, the second inner tube member 171″″′, and/or the second end 161″″′ may be attached by any means including, but not limited to, glue, adhesive, fastener, screw, bolt, welding, or any other means understood by those having the benefit of this disclosure.

The first and second inner tube member 170″″′, 171″″′ and the fastener member 120″″′ may be one tube which may include threaded portions, may be smooth, and/or may include grooves. As illustrated, the first and second inner tube member 170″″′, 171″″′ may include portions which may matingly engage the first and second fitting member 180″″′, 181″″′, respectively.

The grooved member 131″″′ may include a first and second grooved member 132″″′, 133″″′. The first fitting member 180″″′ may matingly engage the first grooved member 132″″′. The second fitting member 181″″′ may matingly engage the second grooved member 133″″′. The first grooved member 132″″′ may be attached to or a portion of the first inner tube member 170″″′ and/or the first compressible sleeve member 174″″′. The distal section 112″′ of the first inner tube member 170″″′ may include the first grooved member 132″″′. The second grooved member 133″″′ may be attached to or a portion of the second inner tube member 171″″′ and/or the second compressible sleeve member 175″″′.

The other elements of this embodiment of the pipe adapter 100″″′ that are not specifically recited herein are labeled with quintuple prime notation, are similar to that of one or more embodiments of the pipe adapter 100, 100′, 100″, 100″′, 100″″ previously described, and require no further discussion herein.

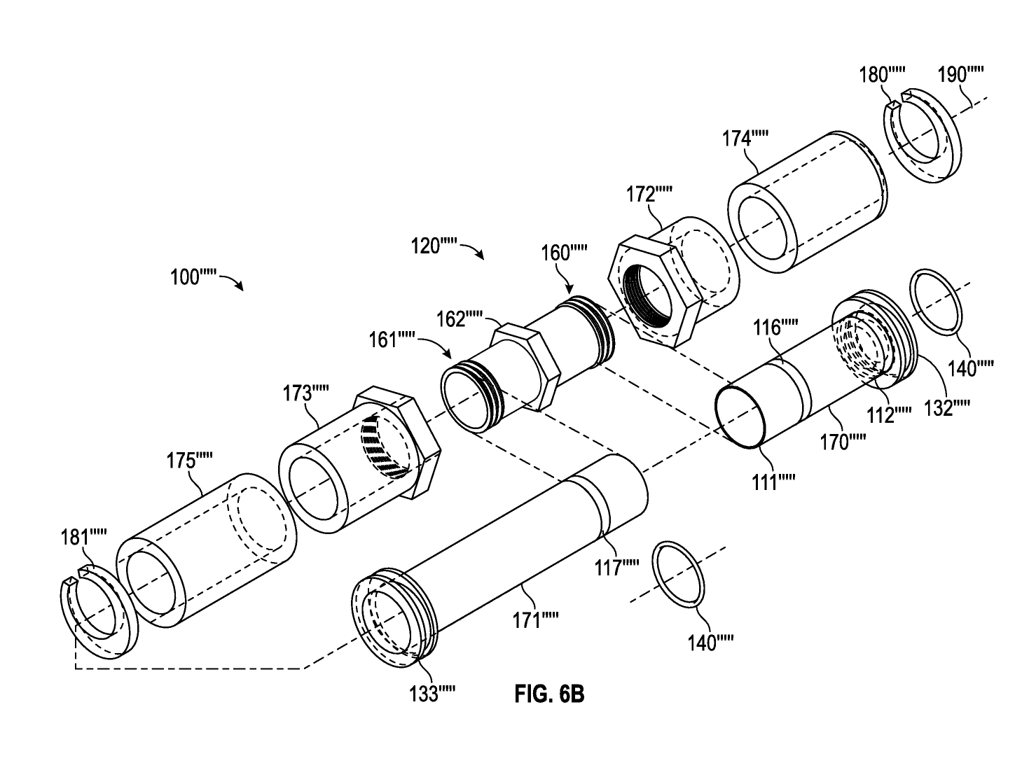

Referring now additionally to FIG. 7, another embodiment of the pipe adapter 100″″″ according to the present invention is now disclosed in greater detail. More specifically, and with reference to the distal end 112″″″ of the inner tube member 110″″″, the distal end 112″″″ of the inner tube member 110″″″ may be tapered. In addition, although not illustrated, the proximal end 111″″″ of the inner tube member may be tapered.

The fitting member 130″″″, or a portion thereof, may be tapered. The fitting member 130″″″ may be expandable and rotating the fastener member 120″″″ or the inner tube member 110″″″ may cause the fitting member 130″″″ and at least a portion of exterior walls thereof to expand outwardly from a longitudinal axis 190″″″ of the inner tube member 110″″″ and in a direction toward an inner surface 201″″″ of the pipe 200″″″.

The other elements of this embodiment of the pipe adapter 100″″″ that are not specifically recited herein are labeled with sextuple prime notation, are similar to that of one or more embodiments of the pipe adapter 100, 100′, 100″, 100″′, 100″″, 100″″′ previously described, and require no further discussion herein.

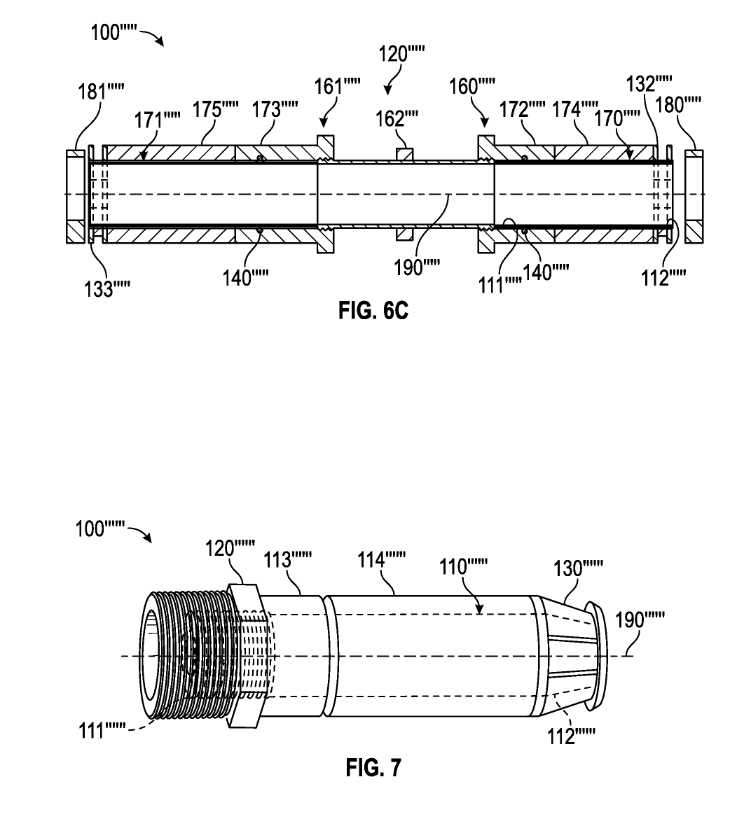

Referring now additionally to FIG. 8, another embodiment of the pipe adapter 100″″″ according to the present invention is now disclosed in greater detail. More specifically, and with reference to the first fitting member 180″″″ , the first fitting member 180″″″ may be a barbed ring. The barbed ring may include a plurality of barbs which may be angled. When the pipe adapter 100″″″ is inserted into the pipe 200″″″, the barbs may not engage or may partially engage the inner surface 201″″″ until pressure or force is exerted in the opposite direction, at which point the barbs may engage the inner surface 201″″″ of the pipe 200″″″.

The other elements of this embodiment of the pipe adapter 100″′ that are not specifically recited herein are labeled with septuple prime notation, are similar to that of one or more embodiments of the pipe adapter 100, 100′, 100″, 100″′, 100″″, 100″″′, 100″″″ previously described, and require no further discussion herein.

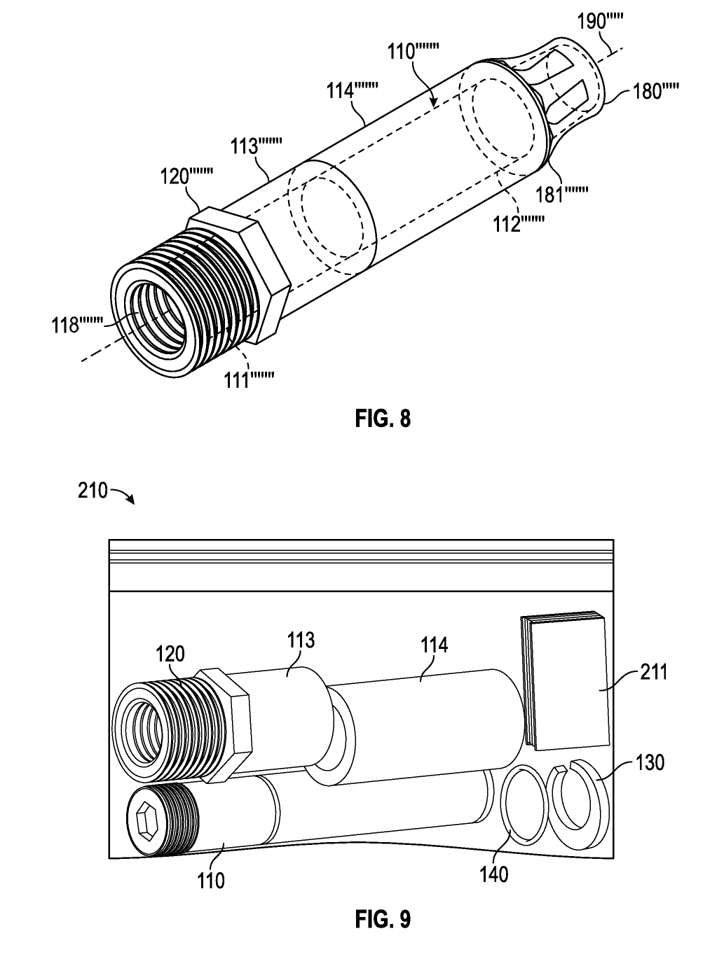

Referring now additionally to FIG. 9, another embodiment of the pipe adapter 100 according to the present invention is now disclosed in greater detail. More specifically, the pipe adapter 100 may be a kit 210. Those skilled in the art will appreciate that the kit 210 may include any of the components discussed herein or components as desired and may further include instructions 211. For example, and without limitation, and as illustrated, the kit 210 may include the inner tube member 110, the outer sleeve member 113, the compressible sleeve member 114, the fastener member 120, the fitting member 130, the O-ring 140, and the instructions 211.

All of the components of the kit 210 may be purchased in the kit 210. The kit 210 may come in a box, a bag, or other package(s). The instructions 211 may instruct a user in how to assemble the components into the pipe adapter 100 and/or how to use the pipe adapter 100. The kit 210 may further include tools required to install the pipe adapter 100 and other fittings, including, but not limited to, a hose bib, bibcock fitting, or other fitting as desired.

A method of installing the pipe adapter 100 may include inserting at least a portion of the inner tube member 110, the outer sleeve member 113, the compressible sleeve member 114, the fastener member 120, and/or the fitting member 130 into a portion of the pipe 200. Rotating the fastener member 120 may cause the compressible sleeve member 114 to expand outwardly from the longitudinal axis 190 of the inner tube member 110 and in a direction generally toward an inner surface 201 of the pipe 200. The compressible sleeve member 114 may be capable of forming a seal with the inner surface 201 of the pipe 200.

The pipe 200, as described herein, is not meant to include only pipes. The pipe 200 is defined to include anything that can receive the pipe adapter 100, including, but not limited to, pipes, valves, fittings, adapters, or any other object that has a substantially hollow inner surface.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A pipe adapter comprising:
an inner tube member having a proximal section and a distal section;
a fastener member connected to the inner tube member along the proximal section thereof;
an outer sleeve member that girdles the inner tube member and is connected to and extends outwardly from the fastener member;
a compressible sleeve member connected to and extending outwardly from the outer sleeve member and positioned to overlie the inner tube member; and
a fitting member connected to the distal section of the inner tube member and in communication with the compressible sleeve member;
wherein at least a portion of at least one of the fitting member and the compressible sleeve member are positionable within a portion of a pipe; and
wherein rotating the fastener member causes the compressible sleeve member to be compressed and at least a portion of exterior walls thereof to expand outwardly from a longitudinal axis of the inner tube member and in a direction toward an inner surface of the pipe.

2. The pipe adapter according to claim 1 wherein the fastener member has a threaded end.

3. The pipe adapter according to claim 2 wherein the fastener member includes a polygonal shaped portion connected to the threaded end.

4. The pipe adapter according to claim 1 wherein the fitting member includes a first fitting member and a second fitting member.

5. The pipe adapter according to claim 4 wherein the first fitting member is a nose cone connected to the distal section of the inner tube member; and wherein the second fitting member is a lock sleeve configured to matingly engage at least a portion of the nose cone.

6. The pipe adapter according to claim 4 wherein the second fitting member is a lock sleeve; and wherein rotation of the fastening member causes the lock sleeve to be compressed so that exterior walls of the lock sleeve expand outwardly from the longitudinal axis and in a direction toward the inner surface of the pipe.

7. The pipe adapter according to claim 4 wherein the first fitting member is a barbed ring.

8. The pipe adapter according to claim 4 wherein the fastener member comprises a first and second fastener member; wherein rotating the first fastener member causes the first fitting member to further matingly engage the second fitting member; and wherein exterior walls of the second fitting member expand outwardly from the longitudinal axis and in a direction toward the inner surface of the pipe; and
wherein rotating the second fastener member causes the compressible sleeve member to be compressed and at least a portion of exterior walls thereof to expand outwardly from the longitudinal axis of the inner tube member and in a direction toward the inner surface of the pipe.

9. The pipe adapter according to claim 1 wherein the fitting member comprises a first fitting member connected to the distal section of the inner tube member and in communication with the compressible sleeve member.

10. The pipe adapter according to claim 9 wherein the fitting member comprises a second fitting member configured to matingly engage the first fitting member; wherein at least a portion of at least one of the first fitting member, the second fitting member, and the compressible sleeve member are positionable within a portion of the pipe.

11. The pipe adapter according to claim 1 further comprising an O-ring positioned between the inner tube member and an interior wall of the outer sleeve member; and wherein the inner tube member comprises a grooved section configured to matingly engage the O-ring.

12. The pipe adapter according to claim 1 wherein an end of the inner tube member is at least one of tapered and threaded.

13. The pipe adapter according to claim 1 wherein outward expansion of the compressible sleeve member is configured to create at least one of a liquid-tight and a gas-tight seal with the pipe.

14. The pipe adapter according to claim 1 wherein the compressible sleeve member is configured in at least one of a series of rings, a helical configuration, and a single piece of material.

15. The pipe adapter according to claim 1 wherein the distal section of the inner tube member comprises a grooved member configured to matingly engage the fitting member.

16. The pipe adapter according to claim 1 wherein the proximal section of the inner tube member comprises an opening that is at least one of polygonal, circular, oval, generally polygonal, generally circular, and generally oval.

17. The pipe adapter according to claim 16 wherein the opening comprises a slot.

18. The pipe adapter according to claim 1 wherein:
the fastener member has a first end, a second end, and a medial section;
the inner tube member comprises a first inner tube member and a second inner tube member, the first inner tube member being connected to and extending outwardly from the first end of the fastener member, and the second inner tube member being connected to and extending outwardly from the second end of the fastener member;
the outer sleeve member comprises a first outer sleeve member that girdles the first inner tube member and is connected to and extends outwardly from the first end of the fastener member, and a second outer sleeve member that girdles the second inner tube member and is connected to and extends outwardly from the second end of the fastener member;
the compressible sleeve member comprises a first compressible sleeve member connected to and extending outwardly from the first outer sleeve member and positioned to overlie the first inner tube member, and a second compressible sleeve member connected to and extending outwardly from the second outer sleeve member and positioned to overlie the second inner tube member;
the fitting member comprises a first fitting member adapted to be connected to the first inner tube member and in communication with the first compressible sleeve member, and a second fitting member adapted to be connected to the second inner tube member and in communication with the second compressible sleeve member;
wherein at least a portion of at least one of the first fitting member and the first compressible sleeve member are positionable within a portion of a first pipe;
wherein at least a portion of at least one of the second fitting member and the second compressible sleeve member are positionable within a portion of a second pipe; and
wherein rotating at least one of the first end and the second end, causes at least a portion of exterior walls of at least one of the first compressible sleeve member and the second compressible sleeve member to expand outwardly from a longitudinal axis of the respective first and second inner tube members in a direction toward an inner surface of the respective first and second pipes.

19. A pipe adapter comprising:
an inner tube member having a proximal section and a distal section;
a first fastener member connected to the inner tube member along the proximal section thereof;
an outer sleeve member that girdles the inner tube member and is connected to and extends outwardly from a second fastener member;
a compressible sleeve member connected to and extending outwardly from the outer sleeve member and positioned to overlie the inner tube member;
a first fitting member connected to the distal section of the inner tube member and in communication with the compressible sleeve member; and
a second fitting member configured to matingly engage the first fitting member;
wherein the second fitting member is a lock sleeve;
wherein at least a portion of at least one of the first fitting member, the second fitting member, and the compressible sleeve member are positionable within a portion of a pipe; and
wherein rotating the second fastener member causes the compressible sleeve member to be compressed and at least a portion of exterior walls thereof to expand outwardly from a longitudinal axis of the inner tube member and in a direction toward an inner surface of the pipe.

20. The pipe adapter according to claim 19 wherein the first fitting member is a nose cone.

21. The pipe adapter according to claim 19 wherein rotating the first fastener member causes the first fitting member to further matingly engage the second fitting member; and wherein exterior walls of the second fitting member expand outwardly from the longitudinal axis and in a direction toward the inner surface of the pipe.

22. A pipe adapter comprising:
a fastener member having a first end, a second end, and a medial section;
a first inner tube member having a proximal section and a distal section wherein the proximal section is connected to the first end of the fastener member and wherein the first inner tube member extends outwardly from the first end of the fastener member;
a second inner tube member connected to and extending outwardly from the second end of the fastener member;
a first outer sleeve member that girdles the first inner tube member and is connected to and extends outwardly from the first end of the fastener member;
a second outer sleeve member that girdles the second inner tube member and is connected to and extends outwardly from the second end of the fastener member;
a first compressible sleeve member connected to and extending outwardly from the first outer sleeve member and positioned to overlie the first inner tube member;
a second compressible sleeve member connected to and extending outwardly from the second outer sleeve member and positioned to overlie the second inner tube member;
a first fitting member adapted to be connected to the distal section of the first inner tube member and in communication with the first compressible sleeve member; and
a second fitting member adapted to be connected to the second inner tube member and in communication with the second compressible sleeve member;
wherein at least a portion of at least one of the first fitting member and the first compressible sleeve member are positionable within a portion of a first pipe; and
wherein at least a portion of at least one of the second fitting member and the second compressible sleeve member are positionable within a portion of a second pipe.

23. The pipe adapter according to claim 22 further comprising an O-ring; and wherein the O-ring girdles at least one of the first and second inner tube member.

24. The pipe adapter according to claim 22 wherein at least one of the first and second fitting member is a nose cone configured to matingly engage at least a portion of a lock sleeve.

25. The pipe adapter according to claim 22 wherein rotating at least one of the first end, the second end, the medial section, the first outer sleeve member, and the second outer sleeve member causes at least one of the first compressible sleeve member and the second compressible sleeve member to be compressed and exterior walls thereof to expand outwardly from a longitudinal axis of the respective first and second inner tube members and in a direction toward an inner surface of the respective first and second pipes.
